(19) United States
(12) Patent Application Publication
(10) Pub. No.: US 2023/0039732 A1
(43) Pub. Date: Feb. 9, 2023

(54) EARTHQUAKE PREDICTION METHOD AND SYSTEM BASED ON GROUND-AIR REMOTE SENSING COUPLING

(71) Applicant: Xiongfei Zeng, Huizhou City (CN)

(72) Inventors: Xiongfei ZENG, Hulzhou City (CN); Yan Zeng, Huizhou City (CN); Jiang Zeng, Huizhou City (CN)

(73) Assignee: Xiongfei Zeng, Huizhou City (CN)

(21) Appl. No.: 17/840,040

(22) Filed: Jun. 14, 2022

(30) Foreign Application Priority Data
Aug. 3, 2021 (CN) 202110885683.3

(51) Int. Cl. G01V 1/00; G06V 20/13

(52) U.S. Cl. CPC G01V 1/008; G06V 20/13

(57) ABSTRACT

The present disclosure provides an earthquake prediction method and system based on ground-air remote sensing coupling. The method includes: acquiring a geomagnetic resonance cell; determining an initial earthquake magnitude, an epicentral distance, and an eruption time based on the geomagnetic resonance cell; determining an epicenter based on the epicentral distance; obtaining a satellite remote sensing cloud image and/or an infrared remote sensing image; determining an initial earthquake magnitude, an epicenter and an earthquake eruption time based on the satellite remote sensing cloud image and/or the infrared remote sensing image; and determining a final earthquake magnitude, a final epicenter and a final earthquake eruption time by analysis by a coupled system based on the geomagnetic resonance cell, the satellite remote sensing cloud image and/or the infrared remote sensing image. By the above method, an earthquake can be predicted.

### CROSS REFERENCE TO RELATED APPLICATION

This patent application claims the benefit and priority of Chinese Patent Application No. 202110885683.3, filed on Aug. 3, 2021, the disclosure of which is incorporated by reference herein in its entirety as part of the present application.

### TECHNICAL FIELD

The present disclosure relates to the technical field of earthquake prediction, and in particular, to an earthquake prediction method and system based on ground-air remote sensing coupling.

### BACKGROUND ART

Earthquakes are the most severe natural hazards for humans for thousands of years, especially for China. There is an urgent need to solve the problem of earthquake prediction. This is an acknowledged problem in the world. It was believed that this problem would be solved by taking several or dozens of generations and even could not be solved.

Although a very few earthquakes had been predicted in China, most of earthquakes could not be predicted and always occurred by chance, including Tangshan and Wenchuan earthquakes that caused modern human tragedies. Fortunately, Qian Fuye, Zhao Yulin, Zhao Biru et al. invented an earthquake prediction and monitoring system by harmonic resonance waves derived by tidal forces (HRT wave), also called a PS100 geoelectricity detector which had significantly improved anti-jamming capability with the introduction of the Code Division Multiple Access (CDMA) technology. They proposed an earthquake prediction method by HRT wave based on measurements of ground resistivity and geoelectric field, rendering the solving of the above problem possible. Due to unclear mechanism of earthquakes, Qian Fuye et al. regarded an earthquake focus as a black box which is hit by tidal forces to form harmonic resonance waves, and found that the magnitude was determined by the period of geoelectric resonance waves and an epicenter was determined by the time difference of arrival of fast and slow geoelectric stations. Since there exist many problems such as theoretical difficulties and difficult identification of signals, the earthquake prediction problem is still not solved fundamentally.

Zeng Xiongfei and his team started from the mechanism of earthquakes, combined the theories of thermodynamics and thermochemical kinetics with a large number of earthquake facts, and found that a seismic structure body (occlusion) is a physical entity and energy storage body, and also a geological entity. An earthquake is divided into three stages: energy accumulation, triggering, and eruption. Moreover, they started from the theory of physical mechanics and found out that the eruption of an earthquake needs to meet a mechanical condition, i.e., the internal pressure of a seismic occlusion needs to exceed the sum of the break strength of the covering strata and the local gravity. With the help of the theory of hydrodynamics, especially the theory of shock wave, it has been found that in the triggering stage of an earthquake, the input of the energy of the seismic occlusion will cause large-scale rupture of the structure body to create a loading wave and an unloading wave that propagate to the outside in the forms of a fast resonance wave and a slow resonance wave. Regardless of geoelectric, geomagnetic or stress strain, it is tenable that a resonance period determines an earthquake magnitude, a time difference of fast and slow waves determines an epicentral distance, and the growth of an explosion chimney (earthquake energy release channel) determines an eruption time. By means of a ground-air coupled system, the accurate prediction of earthquakes is carried into a promising scientific avenue.

### SUMMARY

An objective of the present disclosure is to provide an earthquake prediction method and system based on ground-air remote sensing coupling for accurately predicting an earthquake and achieving the optimal disaster prevention and reduction effects.

To achieve the above objective, the present disclosure provides the following solutions:

An earthquake prediction method based on a ground-air remote sensing coupled system includes:

acquiring a geomagnetic resonance cell;

determining an initial earthquake magnitude, an epicentral distance, and an eruption time based on the geomagnetic resonance cell;

determining an epicenter based on the epicentral distance;

obtaining a satellite remote sensing cloud image and/or an infrared remote sensing image;

determining an initial earthquake magnitude, an epicenter and an earthquake eruption time based on the satellite remote sensing cloud image and/or the infrared remote sensing image; and

determining a final earthquake magnitude, a final epicenter and a final earthquake eruption time by analysis by a coupled system based on the geomagnetic resonance cell, the satellite remote sensing cloud image and/or the infrared remote sensing image.

Further, the determining an initial earthquake magnitude and an epicentral distance based on the geomagnetic resonance cell may specifically include:

determining the initial earthquake magnitude based on a resonance period of the geomagnetic resonance cell; and

determining the epicentral distance based on a time difference of arrival of a fast wave and a slow wave in the geomagnetic resonance cell at a monitoring station.

Further, the determining an epicenter based on the epicentral distance may specifically include:

determining a sequence of epicentral distances based on time differences of arrival of fast waves and slow waves in geomagnetic resonance cells of different earthquakes at monitoring stations; and

making different sequences of concentric circles with the sequence of epicentral distances as radii or diameters and the positions of stations as centers, where intersection points of circular arcs of the sequences of concentric circles on a seismic belt are initial epicenters.

Further, the earthquake prediction method may further include screening strong earthquakes based on the epicenters.

Further, the initial earthquake magnitude is calculated by the following equation:

M=4.16617347(log Tc)+2.81308513,

where M represents the initial earthquake magnitude, and Tc represents the resonance period.

Further, the epicentral distance is calculated by the following equation:

ΔX=6.34068849Δt−14.889826,

where ΔX represents the epicentral distance, and Δt represents the time difference.

The present disclosure further provides an earthquake prediction system based on ground-air remote sensing coupling, including:

an acquisition module configured to acquire a geomagnetic resonance cell;

a first determination module configured to determine an initial earthquake magnitude, an epicentral distance, and an eruption time based on the geomagnetic resonance cell;

an initial epicenter determining module configured to determine an epicenter based on the epicentral distance;

an obtaining module configured to obtain a satellite remote sensing cloud image and/or an infrared remote sensing image;

a second determination module configured to determine an initial earthquake magnitude, an epicenter and an earthquake eruption time based on the satellite remote sensing cloud image and/or the infrared remote sensing image; and

a final determination module configured to determine a final earthquake magnitude, a final epicenter and a final earthquake eruption time by analysis by a coupled system based on the geomagnetic resonance cell, the satellite remote sensing cloud image and/or the infrared remote sensing image.

According to the specific examples provided in the present disclosure, the present disclosure has the following technical effects:

The present disclosure provides an earthquake prediction method and system based on ground-air remote sensing coupling. The method includes: acquiring a geomagnetic resonance cell; determining an initial earthquake magnitude, an epicentral distance, and an eruption time based on the geomagnetic resonance cell; determining an epicenter based on the epicentral distance; obtaining a satellite remote sensing cloud image and/or an infrared remote sensing image; determining an initial earthquake magnitude, an epicenter and an earthquake eruption time based on the satellite remote sensing cloud image and/or the infrared remote sensing image; and determining a final earthquake magnitude, a final epicenter and a final earthquake eruption time by analysis by a coupled system based on the geomagnetic resonance cell, the satellite remote sensing cloud image and/or the infrared remote sensing image. By the above method, an earthquake can be predicted. Especially, an earthquake magnitude, an epicenter, and an eruption time can be determined accurately. Thus, the optimal earthquake prevention and disaster reduction effects can be achieved.

### BRIEF DESCRIPTION OF THE DRAWINGS

To describe the technical solutions in embodiments of the present disclosure or in the prior art more clearly, the accompanying drawings required in the embodiments will be briefly described below. Apparently, the accompanying drawings in the following description show merely some embodiments of the present disclosure, and other drawings can be derived from these accompanying drawings by a person of ordinary skill in the art without creative efforts.

FIG. 1 is a flowchart of an earthquake prediction method based on a ground-air remote sensing coupled system according to an embodiment of the present disclosure.

FIG. 2 is a distribution diagram of major seismic belts and geomagnetic stations in the world.

FIG. 3 is a typical “spider net diagram”.

FIG. 4 illustrates that seismic structure and aerial cloud map are enantiomers of each other

FIG. 5 illustrates geomagnetic curve 02-17 of Beijing provided by Institute of Geology and Geophysics, Chinese Academy of Sciences.

FIG. 6 illustrates epicentral positions shown on a spider net diagram made by a computer.

FIG. 7 illustrates a satellite cloud image 2021-02-18 03:00 (JP).

FIG. 8 illustrates that three major energy supply channels converge on the epicenter at 18:00 on 2103-03-02.

FIG. 9 illustrates a satellite cloud image and an enlarged view thereof at 06:00 on Mar. 3, 2021 (Universal Time Coordinated, UTC).

FIG. 10 illustrates a magnetic strength-time wave diagram of the MH station on Apr. 19, 2021.

FIG. 11 illustrates a spider net diagram of epicentral distances on 2021-04-25.

FIG. 12 illustrates 2104-27 infrared image.

FIG. 13 illustrates a geomagnetic diagram of the MH station on Apr. 20, 2021.

FIG. 14 illustrates a JP spider net diagram made on Apr. 25, 2021.

FIG. 15 illustrates a JP cloud image 2021-04-25 UTC.

FIG. 16 illustrates an RAMMB infrared image 2021-04-25UTC.

FIG. 17 illustrates a magnetic strength-time curve of the BJ station of Institute of Geology and Geophysics, Chinese Academy of Sciences on May 10, 2021.

FIG. 18 illustrates a spider net diagram made by JY and G.

FIG. 19 illustrates a JP cloud image on May 10, 2021.

FIG. 20 illustrates a geomagnetic curve of the BJ geomagnetic station on May 10, 2021 and its enlarged view.

FIG. 21 illustrates a JP cloud image 2021-05-10 18:00:00 (UTC).

FIG. 22 illustrates an RAMMB infrared image 2021-05-10 (UTC) of the Americas.

FIG. 23 illustrates an RAMMB infrared image 2021-05-10 (UTC) of the western Central Pacific.

FIG. 24 illustrates a G2105-10 spider net diagram.

FIG. 25 illustrates a YJ2105-10 spider net diagram.

FIG. 26 illustrates a spider net diagram of two days before the earthquake in Indonesia.

FIG. 27 illustrates a magnetic strength-time spectrum of the BJ station on May 14, 2019.

FIG. 28 illustrates a magnetic strength-time spectrum of the MH station on May 14, 2019.

### DETAILED DESCRIPTION OF THE EMBODIMENTS

The technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments obtained by a common person skilled in the art based on the embodiments of the present disclosure without creative efforts should fall within the protection scope of the present disclosure.

An objective of the present disclosure is to provide an earthquake prediction method and system based on ground-air remote sensing coupling for accurately predicting an earthquake and achieving the optimal disaster prevention and reduction effects.

To make the above objective, features, and advantages of the present disclosure clearer and more comprehensible, the present disclosure will be further described in detail below in conjunction with the accompanying drawings and specific embodiments.

The present disclosure starts from the mechanism of earthquakes, combines the theories of thermodynamics and fluid dynamics with a large number of earthquake facts, discovers a seismic structure body (occlusion) and a resonance cell, and establishes the kinetic theory of seismic structural burst and the fluid dynamic theory of seismic precursors. An earthquake is divided into three stages: energy accumulation, triggering, and eruption. Moreover, they started from the theory of physical mechanics and found out that the eruption of an earthquake needs to meet a mechanical condition, i.e., the internal pressure of a seismic occlusion needs to exceed the sum of the break strength of the overburden rock and the local gravity. With the help of the theory of hydrodynamics, especially the theory of shock wave, it has been found that in the triggering stage of an earthquake, the input of the energy of the seismic occlusion will cause large-scale break of the structure body to create a loading wave and an unloading wave that propagate to the outside in the forms of a fast resonance wave and a slow resonance wave. Regardless of geoelectric, geomagnetic or stress strain, it is tenable that a resonance period determines an earthquake magnitude, a time difference of fast and slow waves determines an epicentral distance, and the growth of an explosion chimney (earthquake energy release channel) determines an eruption time. The present disclosure is intended to achieve accurate earthquake prediction by means of a ground-air coupled system on the basis of the physical mechanisms of a remote sensing cloud image and an infrared remote sensing image.

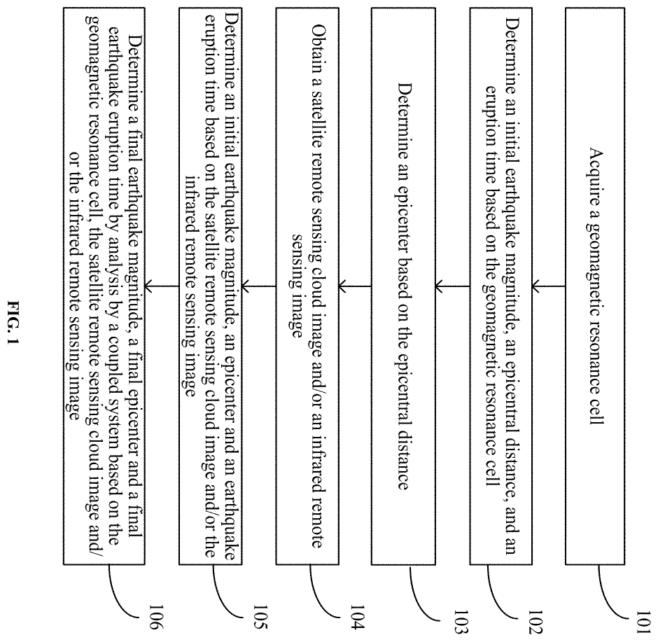

As shown in FIG. 1, an earthquake prediction method based on a ground-air remote sensing coupled system includes the following steps:

Step 101: acquire a geomagnetic resonance cell.

Step 102: determine an initial earthquake magnitude, an epicentral distance, and an eruption time based on the geomagnetic resonance cell.

An earthquake magnitude is determined by a resonance period and calculated by Equation (1):

M=4.16617347(log Tc)+2.81308513 (1),

where M represents the initial earthquake magnitude, and Tc represents the resonance period.

An epicentral distance is determined by a time difference of arrival of a fast wave and a slow wave at a monitoring station and calculated by Equation (2):

ΔX=6.34068849Δt−14.889826 (2),

where ΔX represents the epicentral distance, and Δt represents the time difference.

Step 103: determine an epicenter based on the epicentral distance.

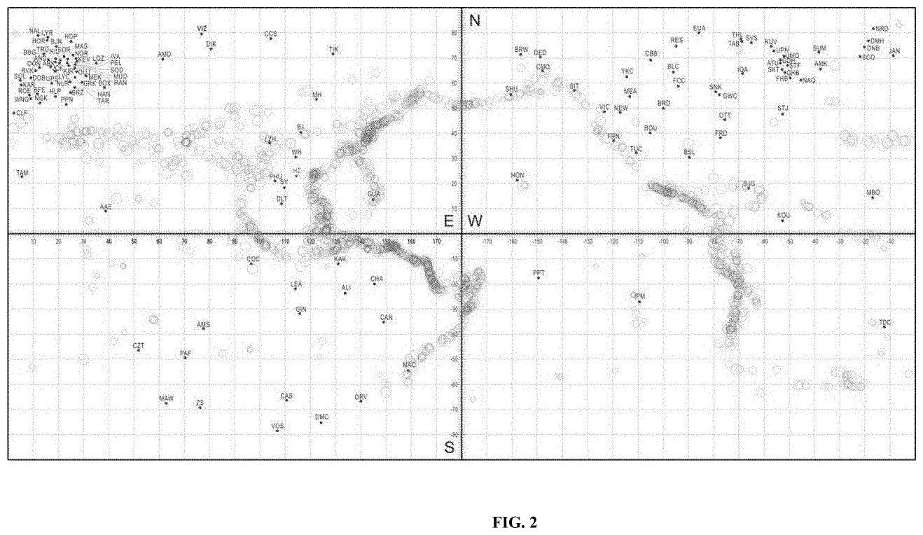

It is most difficult to determine an epicenter. A seismic resonance cell contains a fast wave and a slow wave. The superposition of the two waves is related to phases. The superposition of normal phases results in an increased amplitude, and the superposition of a normal phase and a reversed phase results in a reduced amplitude. With the time of arrival of the fast wave as zero point, the time of arrival of the slow wave is the time difference of the waves, whereby the epicentral distance can be determined. The epicentral distances of different stations can be read from a geomagnetic resonance wave diagram, and a series of concentric circles can be made with the epicentral distances as radii or diameters. An epicenter can be determined from the intersection points of the concentric circles of different stations in a seismic belt. A diagram of global seismic belts is made, mainly including earthquakes at magnitudes 6 and above in recent 100 years and earthquakes at magnitudes 8 and above in recent 1000 years, a total of more than 11,000 earthquakes. The epicenters of such earthquakes are built in a planar isometric expansion diagram of global latitudes and longitudes, and geomagnetic monitoring stations (including Huizhou geoelectric station) are also shown on the diagram according to their latitudes and longitudes, as shown in FIG. 2.

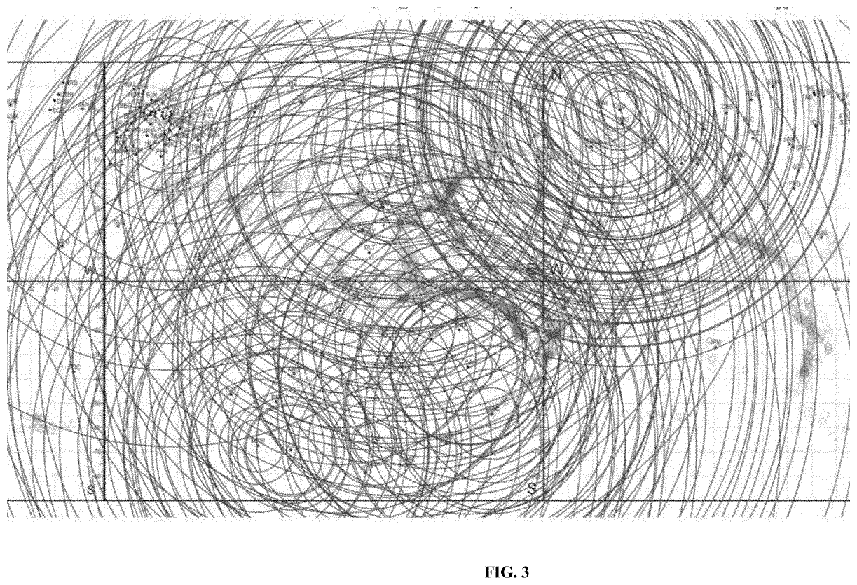

Epicentral positions and destructive earthquakes are screened. An epicenter diagram constructed based on time differences of waves in resonance cells monitored by difference stations that is similar to a spider wed and thus called a “spider net diagram”, as shown in FIG. 3. In the figure, the intersection points in the seismic belt are epicenters. Earthquake elements may be completed in a computer mode or made manually. Earthquake elements may be further determined in conjunction with remote sensing cloud images, especially infrared remote sensing images.

The eruption time of an earthquake is determined by the growth of an explosion chimney (earthquake energy release channel), usually 7 days before the earthquake. Due to different earthquake magnitudes and different earthquake focus depths, the eruption time may be delayed or advanced. Since the explosion chimney has a minimal diameter, “high-frequency waves” often appear when the physical quantities (e.g., magnetic strength, resistivity) of wave motion. On account of an earthquake cloud or infrared wave diagram, characteristic ripples like plum blossoms may appear when the radiation produced by a seismic structure get close enough to the earth's surface. The “high-frequency waves” and the plum blossom-like ripples usually appear 1 to 2 days before an earthquake, whereby the eruption time of the earthquake can be determined. As the distance of the explosion chimney to the earth's surface becomes shorter, the diameter of the explosion chimney becomes smaller and the frequency of resonance waves becomes higher, resulting in formation of peaks. This may appear 4-6 h before an earthquake, which may be taken as an early warning time before the earthquake.

Step 104: obtain a satellite remote sensing cloud image and/or an infrared remote sensing image.

Step 105: determine an initial earthquake magnitude, an epicenter and an earthquake eruption time based on the satellite remote sensing cloud image and/or the infrared remote sensing image.

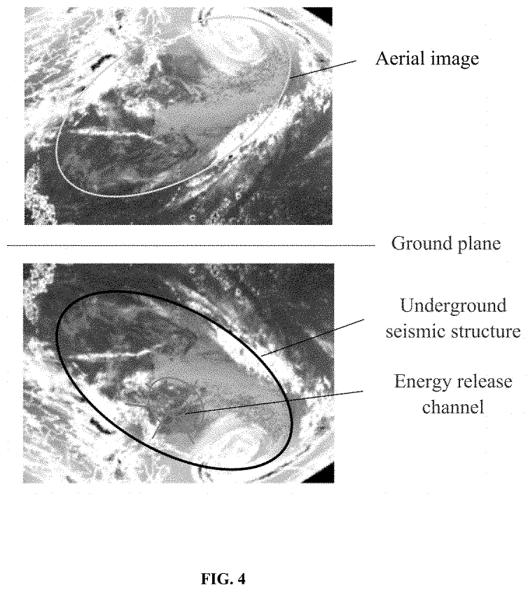

The most significant feature for the triggering stage of seismic development is the excavating of the surrounding rock of the seismic occlusion and the “explosion chimney”, which induces large-scale break. Consequently, large-scale high-energy radiation is produced, and in addition to a portion absorbed by the surrounding rock mass, the vertical portion of the high-energy radiation flows to the upper air and is absorbed by clouds in the upper air. Thus, a typical cloud structure and an infrared characteristic spectrum may be formed. Since important components of rock mass are substances such as calciferous dolomite and granite, maximum absorption takes place in the middle-infrared band, especially at wavelengths 8 μm to 14 μm, and the characteristic spectrum shows a kettle form and exhibits an antipode of the seismic structure. The area of the epicenter exhibits enantiomers of the seismic structure. The area of the epicenter exhibits plum blossom-like ripples and corresponds to the state of the energy release channel, as shown in FIG. 4. Such a spectrum with a seismic structure entity and cloud as antipodes becomes an intuitional means for determining an earthquake epicenter, an eruption time and an earthquake magnitude in the remote sensing technology. By identification, verification and comparison based on such spectra, geomagnetic resonance cells and the “spider net diagram”, the magnitude, the epicenter and the eruption time of an earthquake as well as the early warning time before the earthquake can be accurately determined.

After entering the triggering stage of an earthquake, the resonance cell appears about 7 days before the earthquake, which is referred to as a golden week rule for determining the eruption time. The high-frequency waves of the explosion chimney appear about 2 days before the earthquake. The earthquake cloud including infrared images usually appears about 2 days before the earthquake. The peaks of the resonance waves indicating that the explosion chimney is closest to the earth's surface usually appear 6-10 hours before the earthquake. These can be used to determine the initial earthquake eruption time.

Step 106: perform analysis by a coupled system and comprehensive evaluation based on the geomagnetic resonance cell, the satellite remote sensing cloud image and/or the infrared remote sensing image to determine a final earthquake magnitude, a final epicenter and a final earthquake eruption time by analysis by a coupled system.

The resonance cell and the system thereof involved in the present disclosure, which are not limited to the geomagnetic information, may be geoelectric information, ground resistivity, and/or ground potential, may also be a resonance cell formed by stress and strain, and may also serve as a technical means for finally determining the earthquake magnitude, the epicenter and the eruption time.

The strength of geomagnetism and/or geoelectricity may decrease with an increasing distance of the monitoring station to the epicenter, which may also be used as a reference indicator for finally determining the earthquake magnitude, the epicenter and the eruption time.

A seismic structure is formed by underground surrounding rock, which has a huge size and a huge coverage area, for example, the earthquake at magnitude 9.0 having a structure diameter of up to ten thousand km. After entering the triggering stage of an earthquake, when energy is supplied to the seismic structure from the deep part of the earth, rock will be broken to form a loading wave and an unloading wave. These waves are superposed to form resonance waves. The superposed phases of such waves may be normal phases or reversed phases. The superposition of normal phases results in an increased amplitude, and the superposition of a normal phase and a reversed phase results in a reduced amplitude. Therefore, the superposition of the phases of the resonance waves is also helpful for identifying the epicenter. Accompanied with the rupture and breakage of the surrounding rock of the seismic structure, radiation is released to the earth's surface and air, and infrasonic waves and the like are emitted. These may cause abnormal reactions of animals, ground water anomaly, etc. Such secondary effects will be worthy of reference for earthquake prediction. However, geomagnetism, geoelectricity and satellite remote sensing are leading technical means. If an instrument similar to a night-vision device is further developed to receive infrared radiation during the formation of the explosion chimney, it may be possible for humans to see an earthquake process from triggering to eruption. The epicenter and the eruption time will then be very accurate.

The above method further includes the following step: screen strong earthquakes based on the epicenters. Since the amplitude decreases slowly when the earthquake magnitude is high, earthquakes of relatively high magnitudes usually occur at positions where more arcs intersect. An earthquake cloud and an infrared image that have a large area correspond to an earthquake of a high magnitude. Due to high energy and slow attenuation of a great earthquake or a huge earthquake, the fast geomagnetic slow arrives at the geomagnetic stations distributed worldwide almost at the same time, which may also help us to pick out a great earthquake.

### Specific Example 1

The resonance cell that appeared at Beijing geomagnetic station on Feb. 17, 2021 is taken for example, as shown in FIG. 5 and the enlarged view thereof. The resonance period was read, and the earthquake magnitude was calculated by geomagnetic earthquake magnitude equation (1) to be M7.66, which belonged to a great earthquake.

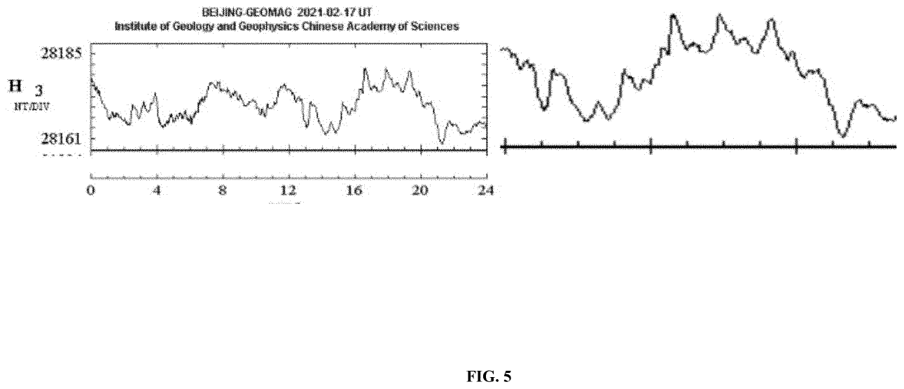

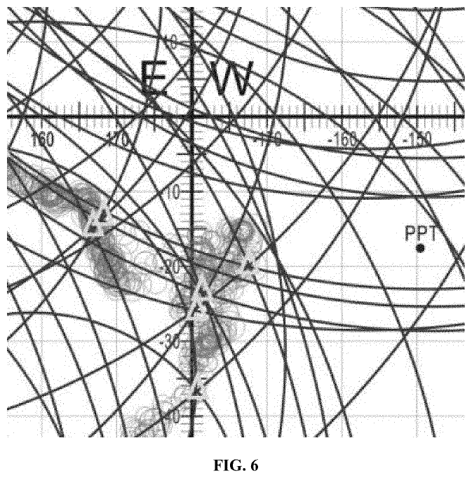

Such a great earthquake would be responded worldwide, i.e., arrived at the geomagnetic stations distributed worldwide almost simultaneously at about 13:00 on February 17 (UTC). The involved internationally shared stations included BJ, MH, SY, and ZS in China, BRW, DED, and CMO in the United States, ALI, CAN, MAC, CAS, GIN, and MAW in Australia, etc. The resulting “spider net diagram” made therefrom showed the epicenter at about 27S and 179W, namely New Zealand, as shown in FIG. 6.

The earthquake cloud information was collected and tracked continuously. FIG. 7 illustrates 2021-02-18 03:00 (JP). FIG. 7 shows a “duck egg-shaped” cloud configuration, which is located in Australia and its eastern sea area. Plum blossom-like ripples are also included therein, which are exactly presentations of the area and the explosion chimney (epicenter) covered by the seismic structure, indicating that the earthquake occurs in New Zealand. Thus, the geomagnetism and the earthquake cloud both showed that the great earthquake occurs in New Zealand, and the monitoring results of the two were consistent.

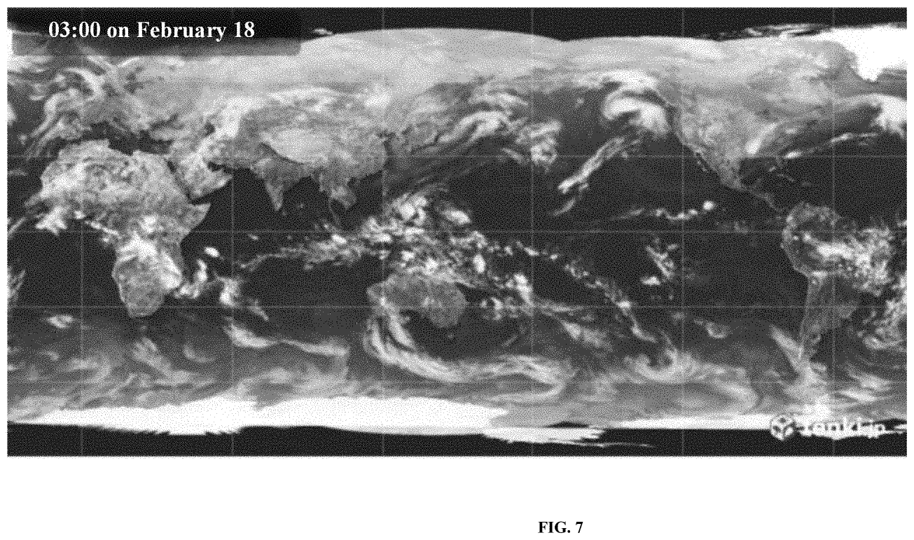

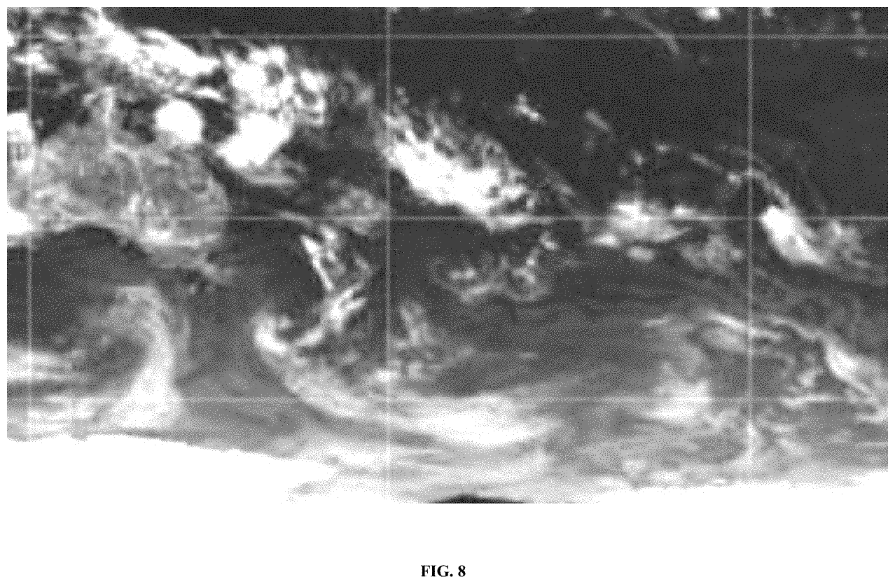

Until 2103-03-02 18:00 (UTC), in the JP cloud image, there is an image showing three major energy supply channels converge on the epicenter, as shown in FIG. 8, indicating that the explosion chimney has already been close to the earth's surface and the earthquakes will erupt in about 2 days.

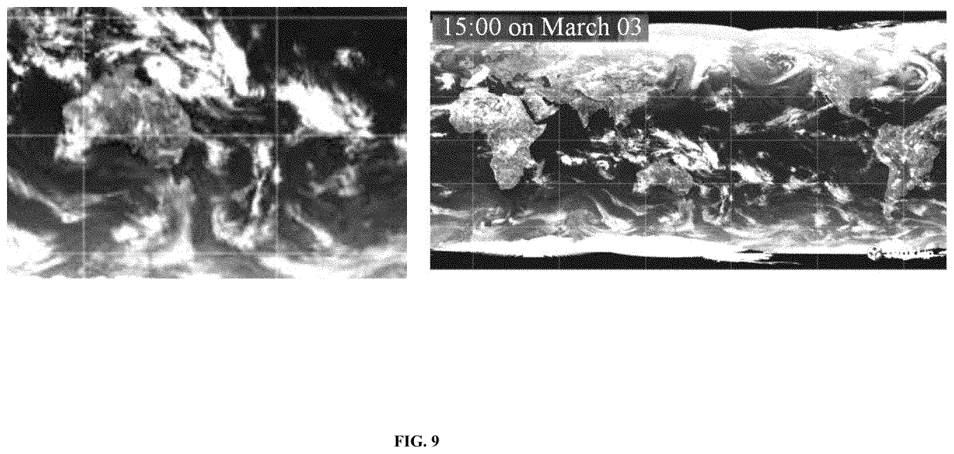

Referring next to the JP cloud image and its enlarged view at 2021-03-03 06:00 (UTC), as shown in FIG. 9, the epicentral structure is extremely clear. There was no doubt that the earthquake would erupt.

### Specific Example 2

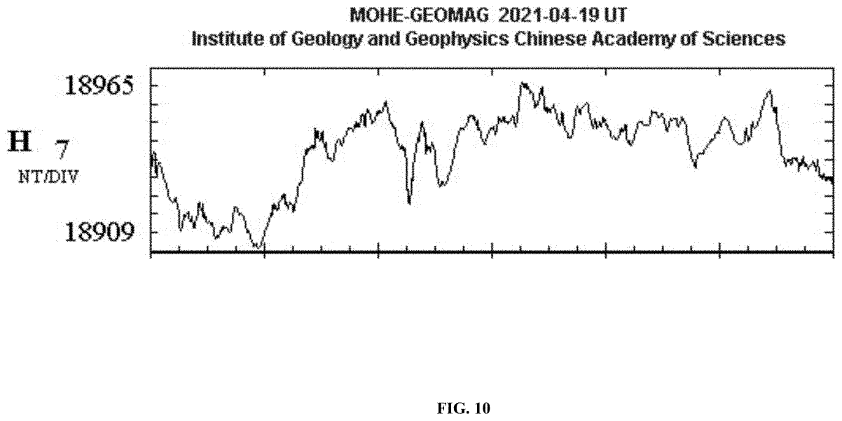

FIG. 10 illustrates the magnetic field strength-time curve of MH geomagnetic station on 2021-04-19, in which each interval represents 1 h. After analysis on the resonance period, a series of earthquakes of about magnitude 6.2, 6.5 at most, were mainly identified. The “spider net diagram” was made by the method similar to that in the first solution, as shown in FIG. 11. This diagram was made on April 25, involving 5 geomagnetic stations, namely BJ, MH, BRW, CAN, and SOL. The epicentral distances of four stations among the five stations accurately intersected at the coordinates of latitude and longitude, 38N141E, in a strong seismic belt, which was the epicenter of the earthquake predicted by the geomagnetism.

Next, see the infrared cloud image. FIG. 12 illustrates 2021-04-27 12:50:00 UTC, an RAMMB infrared spectrum with a wavelength of 11.2 μm. A duck egg-shaped (gourd-shaped) kettle diagram was presented, including plum blossom-like ripples. The darkest part (with the highest energy) was the epicenter. The epicenter given by the spider net diagram was consistent with that given by the infrared cloud image, namely an earthquake occurring in Japan. According to the time of appearing of the cloud image, the earthquake would erupt in 2 days. As measured by China Earthquake Networks Center, the earthquake erupted in Japan at magnitude 6.6, with the time being 2021-05-01 01:27:26.38 (UTC) and the epicenter being 38.25141.90. The prediction accorded with the monitored information.

Besides, a composite coupled system composed of factors such as geoelectricity (resistivity and electric potential), stress-strain, acoustic waves, biological response, and ground water anomaly, and geomagnetism, earthquake cloud, infrared spectrum, etc. has become a composite technical means for accurate earthquake prediction and early warning, improving the reliability and efficacy of earthquake prevention and disaster reduction.

### Specific Example 3

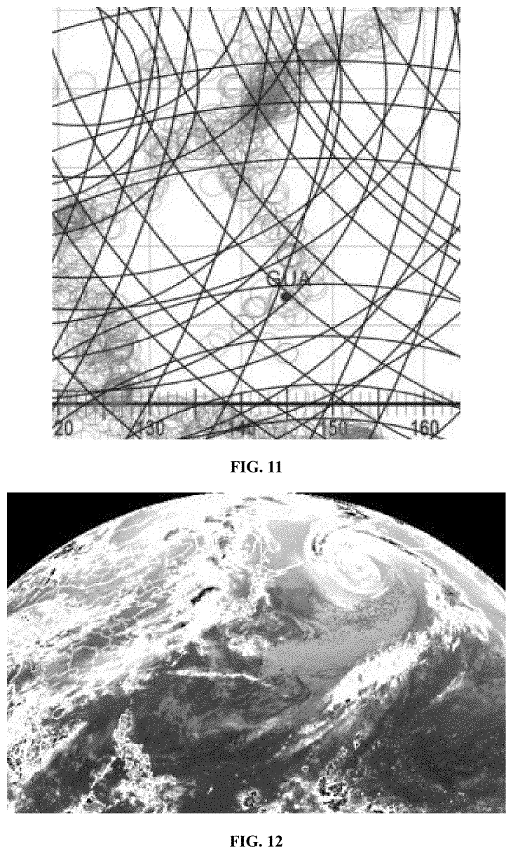

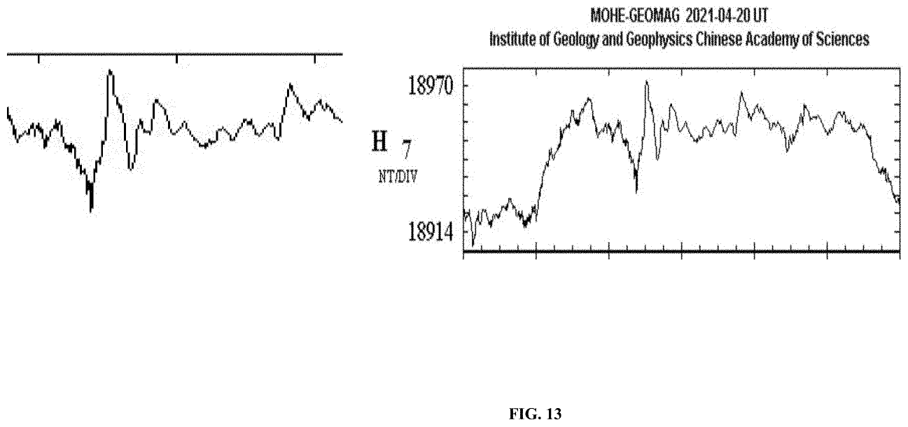

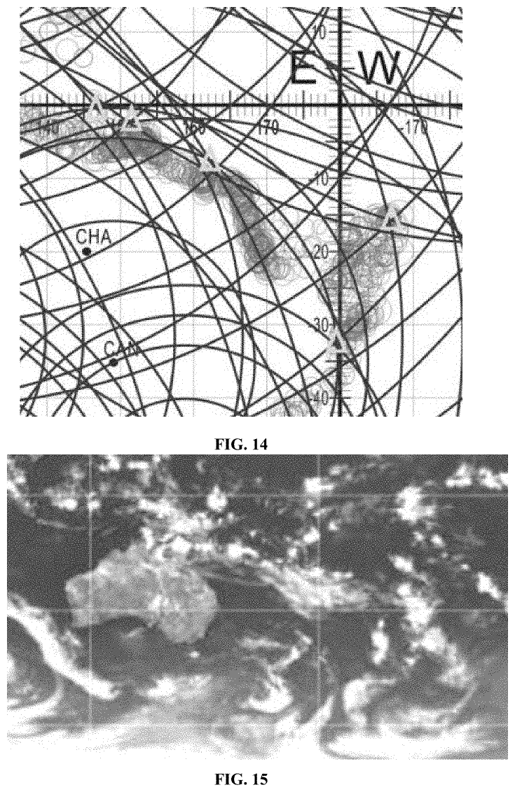

FIG. 13 illustrates the geomagnetic strength-time wave diagram of MH station on 2021-04-20, in which each interval represents 1 h. The figure on the right is an enlarged view thereof. After identification on the period of the resonance waves, this is a resonance wave diagram of an earthquake at magnitude 6.0. Eleven geomagnetic stations, including BJ, MK BRW, DED, CMO, JIN, CAN, MAC, CAS, MAW, YKC, etc., were selected, and the “spider net diagram” was made on the computer. Two epicentral positions were found, of which the coordinates of latitudes and longitudes were −2/148 and −32/−180, respectively, as shown in FIG. 14.

FIG. 15 and FIG. 16 illustrate JP cloud image 2021-04-25 18:00:00 (UTC), and an RAMMB infrared cloud image 2021-04-25 07:30:00 (UTC), respectively. Two similar duck egg-shaped vortexes appear in the two images, actually in New Guinea and New Zealand, respectively.

By comparing the spider net diagram with the cloud image, it was indicated that the epicentral positions should be in New Guinea and New Zealand, namely −2/148 and −32/−180, respectively. Earthquakes would erupt on April 27/28, 2021. The two earthquakes really erupted in the predicted time limits: the first earthquake: M6.1 2021-04-27 08:05:32 (UTC), with the epicenter at 3.415° S145.497° E, Papua New Guinea; and the second earthquake: M6.0, 2021-04-27 16:33:35.5 (UTC), with the epicenter at 29.23S176.91W, New Zealand. The prediction basically accorded with the monitored information.

### Specific Example 4

Prediction on the earthquake in Mauritius:

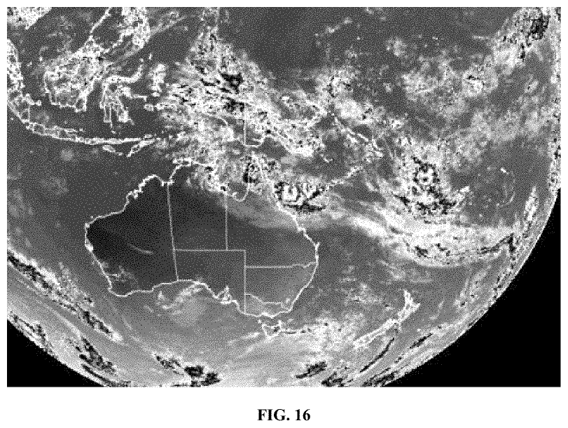

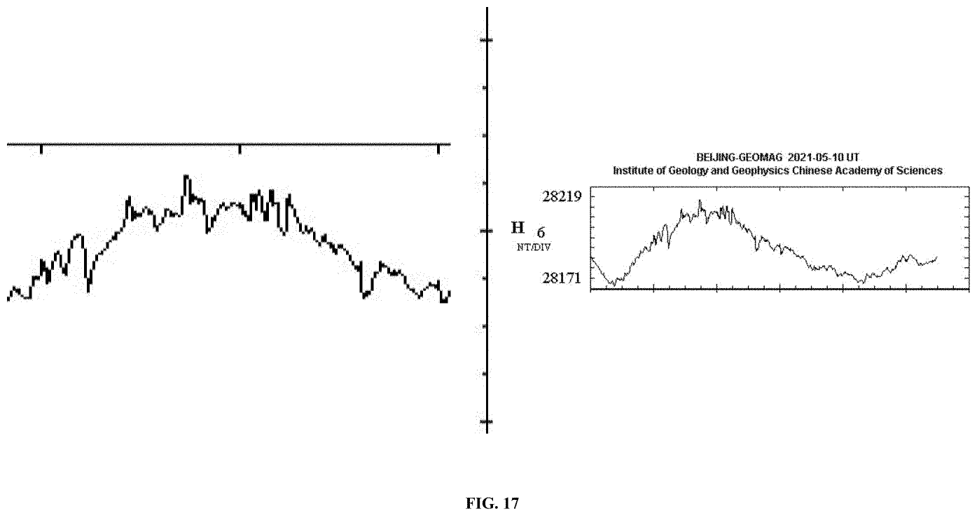

FIG. 17 (the upper figure) and the enlarged view (the lower figure) thereof illustrate the magnetic strength-time diagram of the BJ station of Institute of Geology and Geophysics, Chinese Academy of Sciences on May 10, 2021.

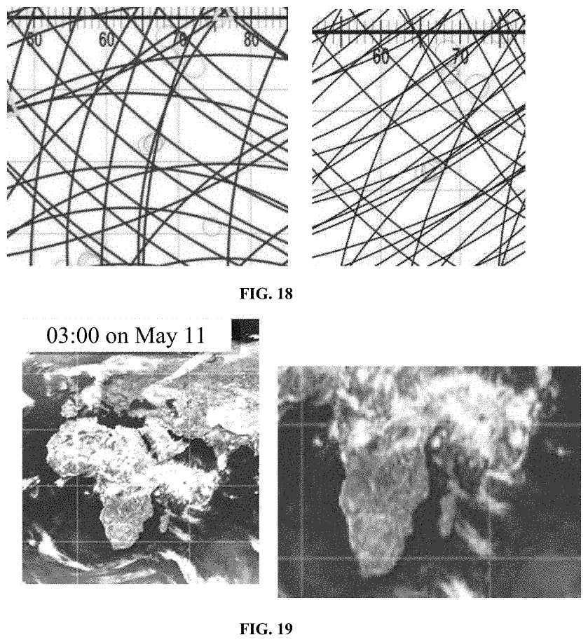

The resonance period was read from the enlarged view, and the calculation results showed that there would be a strong earthquake at magnitude 6.5, and other earthquakes ranging from about 5.7 to 5.9. YJ and G then started to make the “spider net diagram”, with selected geomagnetic stations including Mil, BJ, ZS, BRW, DED, CMO, CAN, CAS, MAC, GIN, SOL, SOD, TRO, WA, etc. As shown on the spider net diagram, −21/66 was pointed out by JY, and −18/67 was pointed out by G, and finally, the epicenter was comprehensively pointed out at −20/66, as shown in FIG. 18.

FIG. 19 (left) and the enlarged view (right) illustrates JP cloud image 2021-05-10 18:00 (UTC), which shows a duck egg-shaped seismic structure in Africa with the epicenter at about −18/60.

Since the epicentral image and plum blossom-like shadow appeared in the earthquake cloud image, the earthquake would erupt in 2 days. It was reported by China Earthquake Networks Center: 2021-05-12 22:05:15 (BJ), earthquake occurring in Mauritius at magnitude 6.5, with the epicenter at −17.30/66.50. Thus, the prediction accorded with the monitored information.

### Specific Example 5

Prediction on 2021 May 10 swarm earthquake:

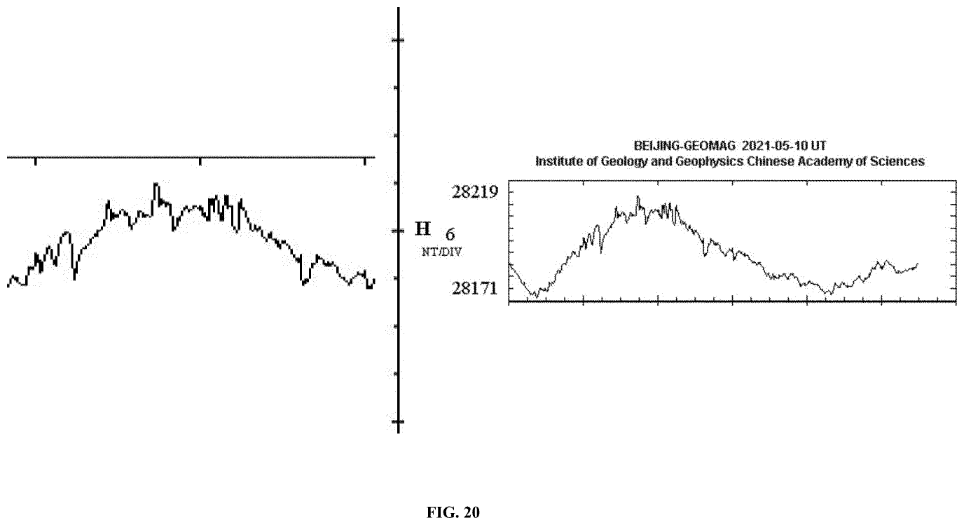

After the earthquake at magnitude 6.6 in Japan erupted on May 1, 2021, the energy supply to the seismic structure from the deep part of the earth was very weak. Changes took place till 2105-10 (29, Chinese lunar calendar). FIG. 20 illustrates the magnetic strength-time diagram of the BJ station of Institute of Geology and Geophysics, Chinese Academy of Sciences (the upper figure) and the enlarged view thereof (the lower figure).

This is a wave diagram of a swarm earthquake at magnitude 6.0. The calculation results showed that there would be a strong earthquake at magnitude 6.5, and other earthquakes at magnitude about 6.0. YJ and G then started to make the 2105-10 “spider net diagram”.

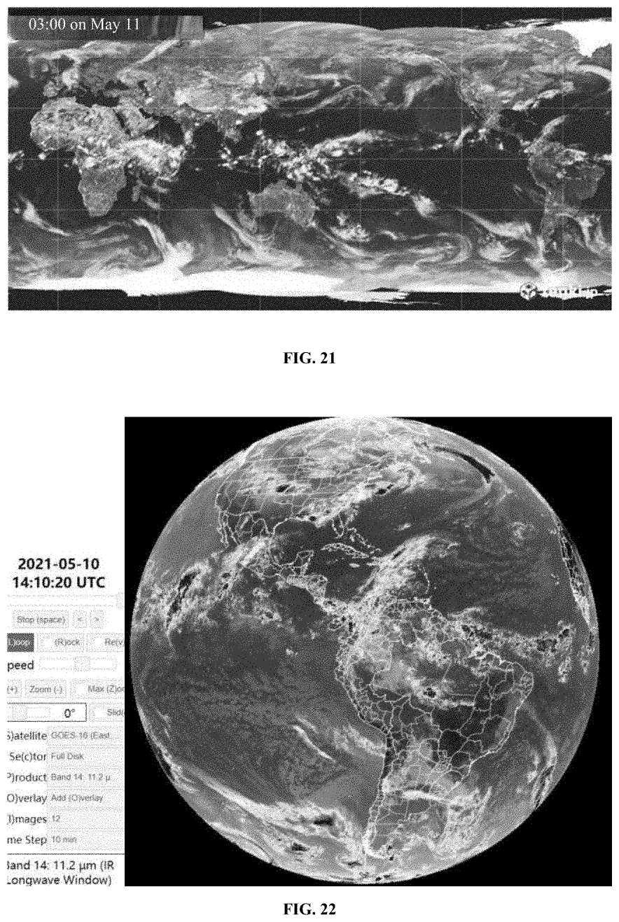

FIG. 21 illustrates JP cloud image 2021-05-10 18:00:00 (UTC), showing several duck egg-shaped vortex images: the first below the Persian Gulf; the second near the equator in western Indonesia; the third in Japan; the fourth above New Zealand; and the fifth in the middle of the Caribbean.

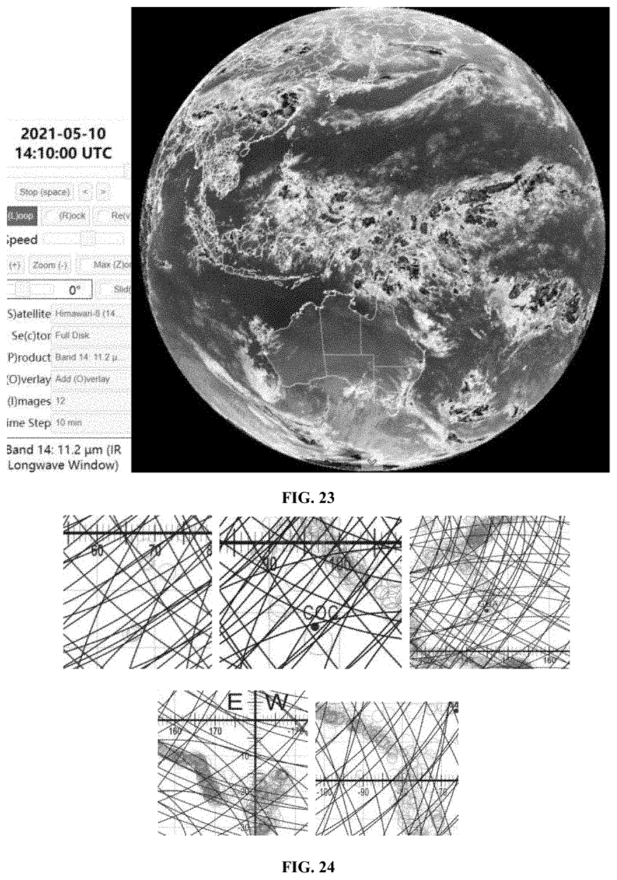

FIG. 22 and FIG. 23 illustrate RAMMB infrared cloud images 2021-05-10 (UTC) for the Americas (FIG. 22) and the Pacific Midwest (FIG. 23), respectively.

In the RAMMB infrared cloud images, the Africa could not be seen clearly, and other regions could not be seen clearly. Several duck egg-shaped vortex images: near the equator in western Indonesia; in Japan; at the top right of New Zealand; and in the middle of the Caribbean. Since plum blossom-like ripples already appeared in the JP cloud image and the RAMMB infrared spectrum, showing the epicenter structures of these earthquakes, which would all erupt in about 3 days.

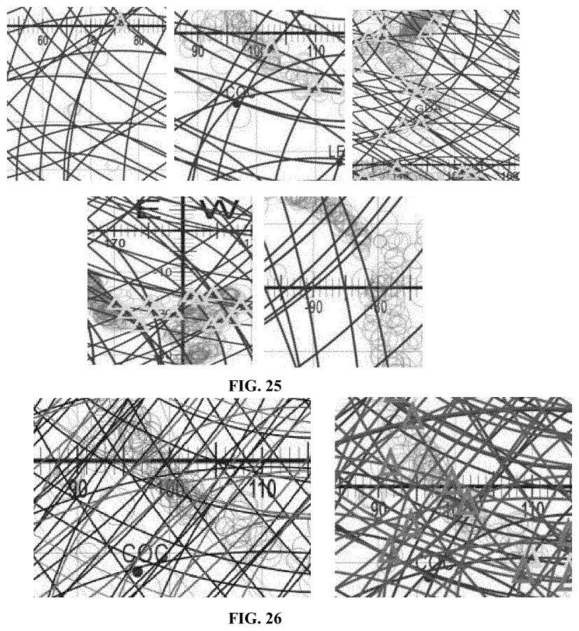

FIG. 24 and FIG. 25 illustrate the “spider net diagrams” made by G and YJ, which were separately constructed according to the mathematical formulas given by the laws of physics and could give the epicenters of the earthquakes quite accurately. The epicentral positions in the figures are sorted as follows: the first in Mauritius, −18/66, −20.5/66; the second in Indonesia, −1/100, −2/98; the third in Japan, 37/143, 39/145; the fourth in Fiji, −20/−179, −17/−177; and the fifth in Panama, 4/−78, 8/−82.

For the earthquake in Indonesia, supplements were made in 2105-12 on the basis of 2105-10. FIG. 26 (the left figure made by G and the right figure made by YJ) illustrates the spider net diagrams made by G and YJ. In the equatorial (near 0°) seismic belt, the epicentral distances of various stations intersected most densely, showing their relatively high magnitudes and more precise epicentral positions.

As monitored by the United States Geological Survey (USGS) and China Earthquake Networks Center, these earthquakes erupted one after another, with their seismic parameters being listed as follows:

Mauritius M6.5, 2021-05-1214:05:15 (UTC), −17.30° 566.50° E;

Panama M6.0, 2021-05-1309:42:12 (UTC) 6.754° N82.386° W;

Japan M6.02021-05-1323:58:14 (UTC) 37.708° N141.778° E;

Fiji M5.7-2021-05-1313:31:35 (UTC) 15.939° S177.443° W;

Indonesia M6.6 2021-05-1406:33:07 (UTC) 0.168° N96.648° E.

It can be seen from the above that the predicted earthquake elements were in good consistency with the monitoring results of the USGS and China Earthquake Networks Center.

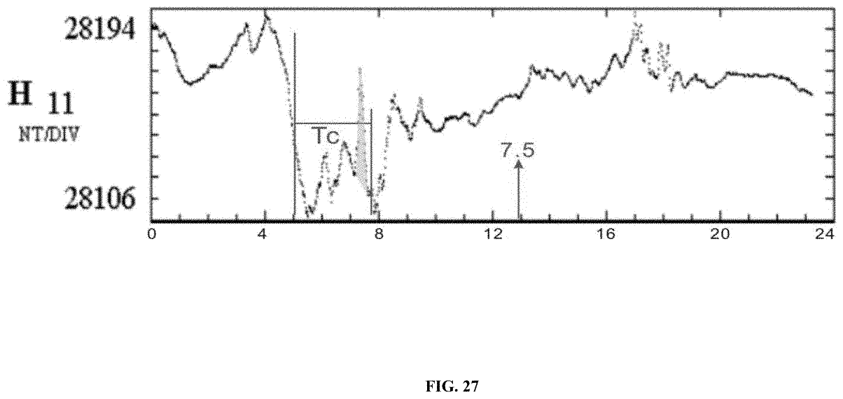

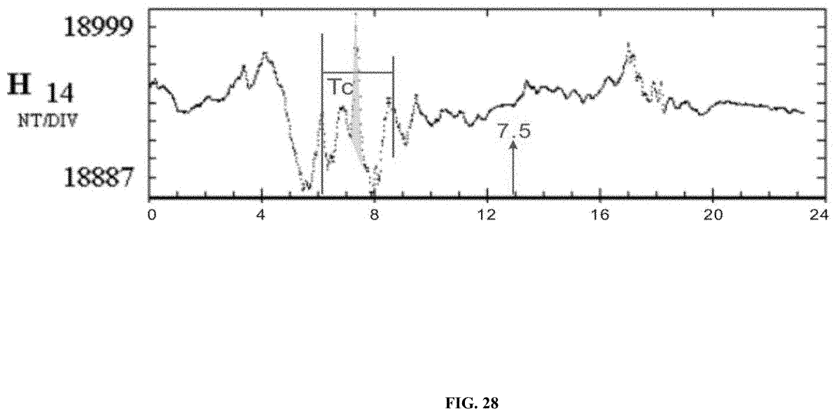

For the seismic precursor monitoring of not only geomagnetism but also geoelectricity and stress-strain, all the resonance cells formed by the seismic structure bodies (seismic occlusions) after the rock break under the action of stress contain the information of magnitudes, epicenters and occurrence of earthquakes, and also include the information on the growth of earthquake energy release channels (explosion chimneys). These are all internal information and physical logic information. Satellite remote sensing information, earthquake clouds, and infrared images are reflections of seismic structure bodies and their rupture motions, which are external information and visual information. Intrinsic information and extrinsic information are antipodes of each other. Earthquakes are the most important manifestations of human-perceivable earth activities, and therefore, the detection of seismic structures is also an important component of the detection of crustal structures. The remote sensing technology can not only identify a seismic structure, but also the movement process of the seismic structure, especially the growth of an explosion chimney. With the progress of the ground remote sensing technology, we can “see” the growth of the earthquake energy release channel-the explosion chimney, approaching the earth's surface day by day, just like one step after another. In the end, the earthquake will erupt. At that time, the prediction of earthquakes will be evolved into the realm of the kingdom of freedom. That day will be realized by humans in a relatively short period of time. Another issue of special significance is pre-earthquake warning. Peak information indicating that the explosion chimney was close to the earth's surface appeared about 6 hours before the earthquake at M7.5 occurring in Papua New Guinea at 12:58:26 on May 14, 2019, as show in FIG. 27 illustrating the 2019-05-14 magnetic strength-time spectrum of the BJ station and in FIG. 28 illustrating the 2019-05-14 magnetic strength-time spectrum of the Mohe station, marked by shadows in the figures. Such information about the explosion chimney had been observed in the geomagnetic strength-time wave diagrams of a large number of earthquakes, and also in the geoelectrical resistivity-time curves. This time could be used as a pre-earthquake warning time.

The present disclosure further provides an earthquake prediction system based on ground-air remote sensing coupling, including:

an acquisition module configured to acquire a geomagnetic resonance cell;

a module for determining an initial earthquake magnitude and an epicentral distance configured to determine an initial earthquake magnitude and an epicentral distance based on the geomagnetic resonance cell;

an initial epicenter determining module configured to determine an epicenter based on the epicentral distance;

an initial earthquake eruption time determining module configured to determine an initial earthquake eruption time based on an earthquake cloud;

an infrared remote sensing cloud image obtaining module configured to obtain an infrared remote sensing cloud image; and

a final determination module configured to determine a final earthquake magnitude, a final epicenter and a final earthquake eruption time based on the infrared remote sensing cloud image.

The embodiments are described herein in a progressive manner. Each embodiment focuses on the difference from another embodiment, and the same and similar parts between the embodiments may refer to each other. Since the system disclosed in an embodiment corresponds to the method disclosed in another embodiment, the description is relatively simple, and reference can be made to the method description.

Specific examples are used herein to explain the principles and embodiments of the present disclosure. The foregoing description of the embodiments is merely intended to help understand the method of the present disclosure and its core ideas; besides, various modifications may be made by a person of ordinary skill in the art to specific embodiments and the scope of application in accordance with the ideas of the present disclosure. In conclusion, the contents of the present description shall not be construed as limitations to the present disclosure.

What is claimed is:

1. An earthquake prediction method based on a ground-air remote sensing coupled system, comprising:
acquiring a geomagnetic resonance cell;
determining an initial earthquake magnitude, an epicentral distance, and an eruption time based on the geomagnetic resonance cell;
determining an epicenter based on the epicentral distance;
obtaining a satellite remote sensing cloud image and/or an infrared remote sensing image;
determining an initial earthquake magnitude, an epicenter and an earthquake eruption time based on the satellite remote sensing cloud image and/or the infrared remote sensing image; and
determining a final earthquake magnitude, a final epicenter and a final earthquake eruption time by analysis by a coupled system based on the geomagnetic resonance cell, the satellite remote sensing cloud image and/or the infrared remote sensing image.

2. The earthquake prediction method based on a ground-air remote sensing coupled system according to claim 1, wherein the determining an initial earthquake magnitude and an epicentral distance based on the geomagnetic resonance cell specifically comprises:
determining the initial earthquake magnitude based on a resonance period of the geomagnetic resonance cell; and
determining the epicentral distance based on a time difference of arrival of a fast wave and a slow wave in the geomagnetic resonance cell at a monitoring station.

3. The earthquake prediction method based on a ground-air remote sensing coupled system according to claim 1, wherein the determining an epicenter based on the epicentral distance specifically comprises:
determining a sequence of epicentral distances based on time differences of arrival of fast waves and slow waves in geomagnetic resonance cells of different earthquakes at monitoring stations; and
making different sequences of concentric circles with the sequence of epicentral distances as radii or diameters and the positions of stations as centers, wherein intersection points of circular arcs of the sequences of concentric circles on a seismic belt are initial epicenters.

4. The earthquake prediction method based on a ground-air remote sensing coupled system according to claim 1, further comprising:
screening strong earthquakes based on the epicenters.

5. The earthquake prediction method based on a ground-air remote sensing coupled system according to claim 1, wherein the initial earthquake magnitude is calculated by the following equation:
M=4.16617347(log Tc)+2.81308513,
wherein M represents the initial earthquake magnitude, and Tc represents the resonance period.

6. The earthquake prediction method based on a ground-air remote sensing coupled system according to claim 1, wherein the epicentral distance is calculated by the following equation:
ΔX=6.34068849Δt−14.889826,
wherein ΔX represents the epicentral distance, and Δt represents the time difference.

7. An earthquake prediction system based on ground-air remote sensing coupling, comprising:
an acquisition module configured to acquire a geomagnetic resonance cell;
a first determination module configured to determine an initial earthquake magnitude, an epicentral distance, and an eruption time based on the geomagnetic resonance cell;
an initial epicenter determining module configured to determine an epicenter based on the epicentral distance;
an obtaining module configured to obtain a satellite remote sensing cloud image and/or an infrared remote sensing image;
a second determination module configured to determine an initial earthquake magnitude, an epicenter and an earthquake eruption time based on the satellite remote sensing cloud image and/or the infrared remote sensing image; and
a final determination module configured to determine a final earthquake magnitude, a final epicenter and a final earthquake eruption time by analysis by a coupled system based on the geomagnetic resonance cell, the satellite remote sensing cloud image and/or the infrared remote sensing image.
